(19) United States
(12) Patent Application Publication
(10) Pub. No.: US 2008/0062721 A1
(43) Pub. Date: Mar. 13, 2008

(54) LIQUID CRYSTAL DISPLAY AND BACK LIGHT MODULE THEREOF

(75) Inventor: Wen-Yu Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: Chunghwa Picture Tubes, LTD., Taipei (TW)

(21) Appl. No.: 11/470,634

(22) Filed: Sep. 7, 2006

(51) Int. Cl. F21V 7/04

(52) U.S. Cl. 362/633

(57) ABSTRACT

A back light module includes a frame, multiple light sources and an optical film. The frame has a bottom and several laterals. The bottom having multiple holes is connected with the laterals. The light sources correspond to the holes, respectively, and are fixed inside the frame. The optical film is disposed on the frame and above the light sources.

### BACKGROUND OF THE INVENTION

1. Field of Invention

The present invention relates to a liquid crystal display. More particularly, the present invention relates to a liquid crystal display and its backlight module, capable of effectively reducing the power consumption and has a relatively high safety.

2. Description of Related Art

The multimedia technology has been well developed in the current society, resulting from the great development in semiconductor device and displaying apparatus. For the displaying apparatus, the liquid crystal display (LCD) apparatus with several advantages of high image quality, high efficiency in using space, low power consumption, no radiation, and so on, has been the main stream in the market. Since the LCD panel itself has no function to emit light, a light source of backlight module is necessarily implemented under the LCD panel, so as to achieve the displaying function.

FIG. 1 is a cross-sectional view, schematically illustrating a conventional LCD. In FIG. 1, the conventional LCD apparatus 100 including a LCD panel 110, a backlight module 120 and an inverter circuit board 130. The LCD panel 110 is disposed above the backlight module 120, and the backlight module 120 can provide the LCD panel 110 with the planar light source, used for displaying image. The inverter circuit board 130 is disposed at side of the backlight module 120, for converting the direct current (DC) power into the alternating current (AC) power in need for driving the backlight module 120.

For example, the backlight module 120 includes multiple CCFL's (cold Cathode Fluorescent Lamps), a frame 124, and a diffusion plate 126. The CCFL's 122 are disposed within the frame 124. In addition, the diffusion plate 126 is disposed on the frame 124, and is positioned above the CCFL's 122.

The foregoing frame 124 is formed from several side plates 124a and a metal back plate 124b, in which the side plates 124a and the metal back plate 124b are connected with each other, and surrounding the metal back plate 124b to form a space, for adapting the CCFL's 122. The lights emitted from each of the CCFL's 122 is initially mixed, and then reaches the diffusion plate 126, so as to form a planar light with a more uniform luminance.

Remarkably, when the backlight module 120 is turned on, since the CCFL's 122 and the metal back plate 124b are very close, a capacitor is formed between the CCFL's 122 and the metal back plate 124b, resulting in the parasitic capacitance between them. In this situation, the current fed to the CCFL 122 not only turns on the CCFL 122 but also charges the capacitor, causing the insufficient current for turning on the CCFL 122. As a result, the luminance of the CCFL 122 cannot reach to the originally required luminance. It is therefore necessary to provide a higher power, so as to allow the CCFL to reach to the originally required luminance. In this situation, it consumes more power.

In general, the design for the backlight module 120 is to be light and thin as much as possible, so as to satisfy the trend of the present displaying apparatus being light and thin. Therefore, under the precondition without increasing the total thickness of the backlight module 120, one way is adjusting the relative position between the CCFL 122 and the metal back plate 124b. In other words, the gap H1 can be increased, so as to reduce the parasitic capacitance between the CCFL 122 and the metal back plate 124b. However, the gap H2 between the CCFL 122 and the diffusion plate 126 is therefore relatively reduced. This way may cause the distance between the CCFL 122 and the diffusion plate 126 to be too small, resulting in poor uniformity of luminance for the planar light source, provided by the backlight module 120.

In addition, the size of the LCD panel 110 is intended to be more and more, the size of the CCFL 122 then is accordingly increasing, and the power for turning on the CCFL 122 is also according increasing. However, the foregoing parasitic capacitance is proportional to the surface area of the CCFL 122. When the driving voltage of the CCFL 122 is higher, the amount of charges accumulated on the metal back plate 124b is larger. In other words, the surface area of the CCFL 122 is larger, or the driving voltage is higher, then the parasitic capacitance between the CCFL 122 and the metal back plate 124b is larger. In this situation, the leakage current between the metal back plate 124b and the CCFL 122 is accordingly larger. This may cause the whole LCD apparatus 100 to be poor safety in operation, and the power consumption of the backlight module 120 certainly increase due to the leakage current. In addition, due to the effect from the parasitic capacitance and the leakage current, the conventional inverter circuit board 130 cannot precisely control the current for exporting to the CCFL 122.

### SUMMARY OF THE INVENTION

The invention provides a backlight module, for solving the conventional backlight module with the disadvantages on the issues of leakage current and large power consumption.

The invention provides a backlight module, so as to improve the safety in operation for the whole LCD apparatus.

The invention provides a backlight module, including a frame, multiple light sources and an optical film. The frame has a bottom and several laterals. The bottom having multiple holes in separation is connected with the laterals. The light sources correspond to the holes, respectively, and are fixed inside the frame. The optical film is disposed on the frame and above the light sources.

According to an embodiment of the invention, the foregoing backlight module further includes an insulating reflection plate, disposed on the bottom.

According to an embodiment of the invention, in the foregoing backlight module, a material for the insulating reflection plate can include polypropylene (PP) or PolyethyleneTerephthalate (PET).

According to an embodiment of the invention, in the foregoing backlight module, the light sources include CCFL, external electrode fluorescent lamp (EEFL), cold cathode fluorescence flat lamp (CCFFL), or light-emitting diode (LED).

According to an embodiment of the invention, in the foregoing backlight module, the optical film includes diffusion plate, brightness enhancement plate, prism plate, or the combination thereof.

The invention provides a LCD apparatus, including the foregoing backlight module and a LCD panel. The LCD panel is disposed over the optical film of the backlight module.

The invention provides backlight module, including a frame, multiple light source, and an optical film. The frame has a bottom and several laterals. The bottom having multiple concave regions in separation is connected with the laterals. The light sources correspond to the concave regions, respectively, and are fixed inside the frame. The optical film is disposed on the frame and above the light sources.

According to an embodiment of the invention, in the foregoing backlight module, the concave regions can be concave surface.

According to an embodiment of the invention, in the foregoing backlight module, the concave regions can be arc surfaces.

According to an embodiment of the invention, in the foregoing backlight module, the light sources can be respectively located at centers of the concave regions.

According to an embodiment of the invention, the foregoing backlight module further includes an insulating reflection plate, disposed on the bottom.

According to an embodiment of the invention, in the foregoing backlight module, a material for the insulating reflection plate can include polypropylene (PP) or PolyethyleneTerephthalate (PET).

According to an embodiment of the invention, in the foregoing backlight module, the light sources include CCFL, external electrode fluorescent lamp (EEFL), cold cathode fluorescence flat lamp (CCFFL), or light-emitting diode (LED) array.

According to an embodiment of the invention, in the foregoing backlight module, the optical film includes diffusion plate, brightness enhancement plate, prism plate, or the combination thereof.

The invention provides backlight module, including a frame, multiple light source, and an optical film. The frame has a bottom and several laterals. The bottom is connected with the laterals. The bottom has multiple holes and multiple concave regions. The holes and the concave regions are alternatively disposed along a first direction, and the holes and the concave regions are alternatively disposed along a second direction. The first direction is substantially perpendicular to the second direction. In addition, the light sources correspond to the first direction are fixed inside the frame. The optical film is disposed on the frame and above the light sources.

According to an embodiment of the invention, in the foregoing backlight module, the concave regions can be concave surface.

According to an embodiment of the invention, in the foregoing backlight module, the concave regions can be arc surfaces.

According to an embodiment of the invention, in the foregoing backlight module, the light sources can be respectively located at centers of the concave regions.

According to an embodiment of the invention, the foregoing backlight module further includes an insulating reflection plate, disposed on the bottom.

According to an embodiment of the invention, in the foregoing backlight module, a material for the insulating reflection plate can include polypropylene (PP) or PolyethyleneTerephthalate (PET).

According to an embodiment of the invention, in the foregoing backlight module, the light sources include CCFL, external electrode fluorescent lamp (EEFL), cold cathode fluorescence flat lamp (CCFFL), or light-emitting diode (LED) array.

According to an embodiment of the invention, in the foregoing backlight module, the optical film includes diffusion plate, brightness enhancement plate, prism plate, or the combination thereof.

The invention provides a LCD apparatus, including the foregoing backlight module and a LCD panel. The LCD panel is disposed over the optical film of the backlight module.

In summary, for the backlight module of the LCD apparatus of the invention, the light sources are corresponding to the through holes or the concave regions, and fixed inside the frame. Under the precondition without changing the thickness of the backlight module, it is helpful to reduce the problem of parasitic capacitance, caused by the too close in distance between the light sources and the bottom of the frame, and then to reduce the power consumption of the backlight module, so as to prevent the leakage current from occurring. In addition, the safety in operation for the whole LCD apparatus can be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view, schematically illustrating a conventional LCD apparatus.

FIG. 2 is a cross-sectional view, schematically illustrating a LCD apparatus, according to a first embodiment of the invention.

FIG. 3 is a cross-sectional view, schematically illustrating a LCD apparatus, according to a second embodiment of the invention.

FIG. 4A is a bottom view, schematically illustrating a LCD apparatus, according to a third embodiment of the invention.

FIG. 4B is a schematic cross-sectional view of FIG. 4A along the line A-A′.

### DESCRIPTION OF THE PREFERRED EMBODIMENTS

### First Embodiment

FIG. 2 is a cross-sectional view, schematically illustrating a LCD apparatus, according to a first embodiment of the invention. In FIG. 2, the LCD apparatus 200 includes a LCD panel 210 and a backlight module 220. The LCD panel is disposed over the backlight module 220, and the backlight module 220 is suitable for providing a planar light to the LCD panel 210, so as to allow the LCD panel 210 for displaying. In general, an inverter circuit board 230 can be implemented at side of the backlight module 220, so as to properly convert the DC power into the AC power for turning on the backlight module 220.

As can be seen from FIG. 2, the backlight module 220 includes several light sources 222, a frame 224, and an optical film 226. The frame 224 has several laterals 224a and a bottom 224b. Remarkably, the bottom 224b has several holes C in separation, and the bottom 224b is connected with the laterals 224a. The light sources 222 are corresponding to the holes C, respectively, and are fixed inside the frame 224. Usually, the light sources 222 can include cold cathode fluorescent lamp (CCFL), external electrode fluorescent lamp (EEFL), cold cathode fluorescent flat lamp (CCFFL), or LED. The one in ordinary skill of the art can select the proper one of those different kind of light sources 222, without limitation.

In addition, the optical film 226 is disposed over the frame 224, and locating above the light sources 222. The optical film can include diffusion plate, brightness enhancement plate, prism plate, or the combination thereof. In detail, the LCD panel 210 is disposed over the optical film 226. If the optical film 226 is the diffusion plate, the lights emitted from the light sources 222 pass through the optical film 226, so as to have a planar light with better uniformity of brightness. If the optical film 226 is prism plate, the prim plate can be used to adjusting the direction of the light from the light sources 222.

It should be noted that the bottom 224b of the invention is formed with holes C, and the light sources 222 are, respectively, disposed in corresponding to the holes C. As a result, under the condition that the total thickness H of the backlight module 220 and the relative locations between the light sources 222 and the bottom 224b can be sustained, the parasitic capacitance between the light sources 222 and the bottom 224b can be effectively reduced. Certainly, here, the shape for the holes C is not limited by the above. The shape of the holes C can be properly adjusted, according to the size, the shape or the number of the light sources 222.

In other words, the backlight module 220 of the invention not only can effectively reduce the leakage current, which is caused by the effect of parasitic capacitance resulting in charge accumulation at the bottom 224b. Further, the invention can improve the safety in operation of the backlight module 220. In addition, the inverter circuit board 230 can precisely control the expected current to export to the light sources 222. The light sources 222 can perform in accordance with the need of the LCD panel 210 for displaying image.

Remarkably, the invention needs not to change the position of the light sources 222, so that a relative position between the light sources 222 and the optical film 226 can be sustained at the original condition. This can prevent the phenomenon of non-uniform brightness for the light emitted from the optical film 226 from occurring, due to improper position adjustment of the light sources 222 with over closing to the optical film 226.

Further, in the embodiment, an insulating reflection plate R can be further disposed on the bottom 224b, so that the light emitted from the light sources 222 can be reflected back by the insulating reflection plate R for more efficient re-use. A material of the insulating reflection plate R can be polypropylene (PP) or PolyethyleneTerephthalate (PET).

### Second Embodiment

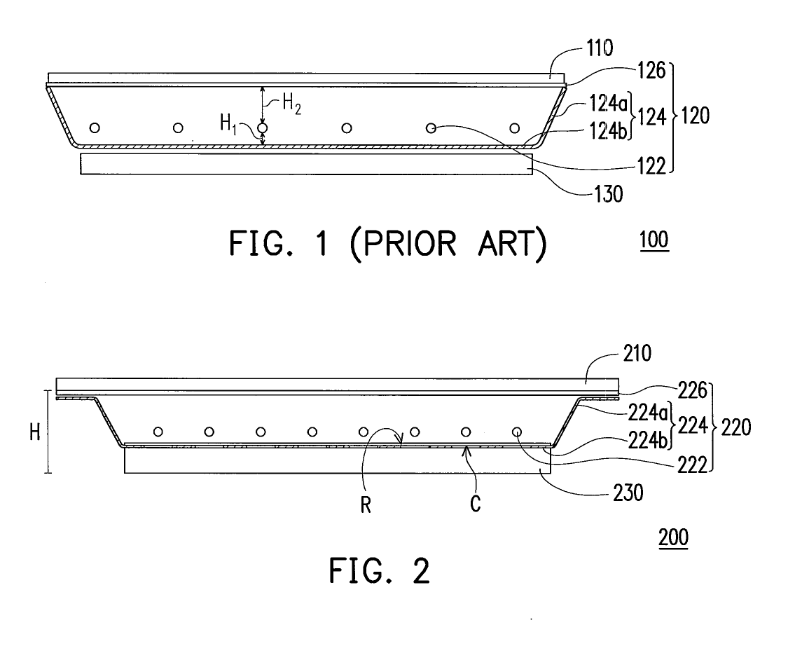

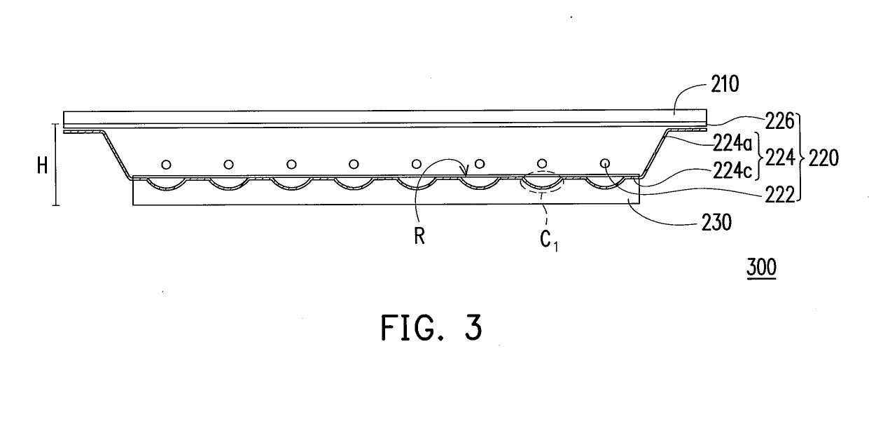

FIG. 3 is a cross-sectional view, schematically illustrating a LCD apparatus, according to a second embodiment of the invention. In FIG. 3, the second embodiment is similar to the first embodiment. However, the difference between the two embodiments is that the bottom 224c of the backlight module 220 in the embodiment has several concave regions C1 in separation. The light sources 222 are respectively corresponding to the concave regions C1 and fixed inside the frame 224. The concave regions C1 can be designed with an arc surface. The light sources 222 can be disposed over the curvature center of the arc surface. In another words, this embodiment uses the concave region C1 to reduce the conventional issues of parasitic capacitance and leakage current, which are caused by an over closing between the CCFL 122 and the metal back plate 124b, as shown in FIG. 1. Remarkably, the shape of the concave region C1 is not limited to the foregoing descriptions. The shape of the concave region C1 can be changed in accordance with the size, the shape, or the number of the light sources 222.

### Third Embodiment

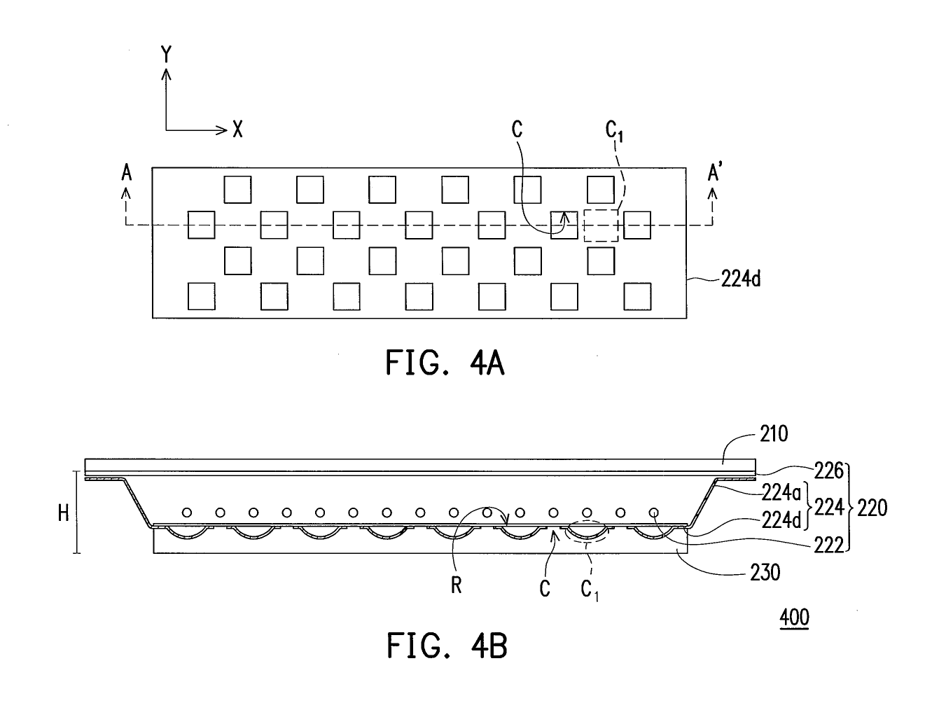

FIG. 4A is a bottom view, schematically illustrating a LCD apparatus, according to a third embodiment of the invention. FIG. 4B is a schematic cross-sectional view of FIG. 4A along the line A-A′. In FIG. 4A and FIG. 4B, the bottom 224d of the LCD 400 in the embodiment is formed with several concave regions C1 and holes C. The concave regions C1 and the holes C are alternatively disposed along a first direction X, and the concave regions C1 and the holes C are also alternatively disposed along a second direction Y The first direction X is substantially perpendicular to the second direction Y.

In detail, the first direction X can be a horizontal direction, and the second direction Y can be the vertical direction. However, the invention is not limited to this option. In addition, the extending direction of each light source 222 can be optionally corresponding to the first direction X or the second direction Y Remarkably, the alternatively disposing manner of the concave region C1 and the holes C can effectively reduce the parasitic capacitor between the light sources 222 and the corresponding bottom 224d. The foregoing concave regions C1 are, for example, a concave surface. The concave surface can be designed with an arc surface. The light sources 222 can be located at the center of the concave surface. Certainly, the shape of the concave regions C1 and the holes is not limited to the foregoing descriptions. The shape of the concave regions C1 and the holes can be changed in accordance with the size, the shape, or the number of the light sources 222.

Remarkably, under the condition without changing the thickness H of the backlight module 220, the shape of the inverter circuit board 230 can be properly change in association with the shape of the concave regions C1.

In summary, the LCD apparatus and the backlight module of the invention at least have the advantages as follows:

Since the light sources are corresponding to the hole or the concave region, and fixed inside the frame, under the precondition without changing the thickness of the backlight module and the relative position between the light sources and the optical film, the invention can effectively reduce the problem of parasitic capacitance, caused by the too close in distance between the light sources and the bottom of the frame. It then reduces the power consumption of the backlight module and prevents the leakage current from occurring. In addition, since the relative position between the light sources and the optical film, this is helpful to sustain the uniform brightness of the planar light, formed by the light emitting from the light sources and passing through the optical film.

Since the leakage current occurring on the backlight module can be effectively reduced, the total power consumption of the LCD apparatus of the invention in operation can be greatly reduced.

Since the backlight module of the invention can effectively reduce the parasitic capacitance and the leakage current, the inverter circuit board can precisely control the current, which is fed to the light sources.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A backlight module, comprising:
a frame, having a bottom and a plurality of laterals, wherein the bottom has a plurality of holes disposed apart from each other, and the bottom is connected with the laterals;
a plurality of light sources, respectively corresponding to the holes and fixed inside the frame; and
an optical film, disposed on the frame and located above the light sources.

2. The backlight module of claim 1, further comprising an insulating reflection plate, disposed on the bottom.

3. The backlight module of claim 2, wherein a material for the insulating reflection comprises plate polypropylene (PP) or PolyethyleneTerephthalate (PET).

4. The backlight module of claim 1, wherein the light sources comprises cold cathode fluorescence lamp (CCFL), external electrode fluorescent lamp (EEFL), cold cathode fluorescence flat lamp (CCFFL), or light-emitting diode (LED).

5. The backlight module of claim 1, wherein the optical film comprises a diffusion plate, a brightness enhancement plate, a prism plate, or a combination thereof.

6. A liquid crystal display (LCD) apparatus, comprising:
a backlight module, comprising:
a frame, having a bottom and a plurality of laterals, wherein the bottom has a plurality of holes disposed apart from each other, and the bottom is connected with the laterals, the laterals are connected to each other;
a plurality of light sources, respectively corresponding to the holes and fixed inside the frame; and
an optical film, disposed on the frame and located above the light sources; and
a LCD panel, disposed over the optical film.

7. The LCD apparatus of claim 6, further comprising an insulating reflection plate, disposed on the bottom.

8. A backlight module, comprising:
a frame, having a bottom and a plurality of laterals, wherein the bottom has a plurality of concave regions disposed apart from each other, and the bottom is connected with the laterals;
a plurality of light sources, respectively corresponding to the concave regions and fixed inside the frame; and
an optical film, disposed on the frame and located above the light sources.

9. The backlight module of claim 8, wherein the concave regions are concave surfaces.

10. The backlight module of claim 9, wherein the concave surfaces are arc surfaces.

11. The backlight module of claim 9, wherein each of the light sources is respectively located at a center of one of the concave surfaces.

12. The backlight module of claim 8, further comprising an insulating reflection plate, disposed on the bottom.

13. The backlight module of claim 12, wherein a material for the insulating reflection comprises plate polypropylene (PP) or PolyethyleneTerephthalate (PET).

14. The backlight module of claim 8, wherein the light sources comprises cold cathode fluorescence lamp (CCFL), external electrode fluorescent lamp (EEFL), cold cathode fluorescence flat lamp (CCFFL), or light-emitting diode (LED).

15. The backlight module of claim 8, wherein the optical film comprises a diffusion plate, a brightness enhancement plate, a prism plate, or a combination thereof.

16. A liquid crystal display (LCD) apparatus, comprising:
a backlight module, comprising:
a frame, having a bottom and a plurality of laterals, wherein the bottom has a plurality of concave regions in separation, and the bottom is connected with the laterals, the laterals are connected to each other;
a plurality of light sources, respectively corresponding to the concave regions and fixed inside the frame; and
an optical film, disposed on the frame and located above the light sources; and
a LCD panel, disposed over the optical film.

17. The LCD apparatus of claim 16, wherein the concave regions are concave surfaces.

18. The LCD apparatus of claim 17, wherein the concave surfaces are arc surfaces.

19. The LCD apparatus of claim 17, wherein each of the light sources is respectively located at a center of one of the concave surfaces.

20. The LCD apparatus of claim 16, further comprising an insulating reflection plate, disposed on the bottom.

21. A backlight module, comprising:
a frame, having a bottom and a plurality of laterals, wherein the bottom is connected to the laterals, the bottom has a plurality of holes and concave regions, the holes and the concave regions are alternatively disposed along a first direction, the holes and the concave regions are alternatively disposed along a second direction, and the first direction is substantially perpendicular to the second direction;
a plurality of light sources, respectively corresponding to the first direction and fixed inside the frame; and
an optical film, disposed on the frame and located above the light sources.

22. The backlight module of claim 21, wherein the concave regions are concave surfaces.

23. The backlight module of claim 22, wherein the concave surfaces are arc surfaces.

24. The backlight module of claim 23, wherein each of the light sources is respectively located at a center of one of the concave surfaces.

25. The backlight module of claim 21, further comprising an insulating reflection plate, disposed on the bottom.

26. The backlight module of claim 25, wherein a material for the insulating reflection comprises plate polypropylene (PP) or PolyethyleneTerephthalate (PET).

27. The backlight module of claim 21, wherein the light source comprises the light sources comprises cold cathode fluorescence lamp (CCFL), external electrode fluorescent lamp (EEFL), cold cathode fluorescence flat lamp (CCFFL), or light-emitting diode (LED).

28. The backlight module of claim 21, wherein the optical film comprises a diffusion plate, a brightness enhancement plate, a prism plate, or a combination thereof.

29. A liquid crystal display (LCD) apparatus, comprising:
a frame, having a bottom and a plurality of laterals, wherein the bottom is connected to the laterals, the bottom has a plurality of holes and concave regions, the holes and the concave regions are alternatively disposed along a first direction, the holes and the concave regions are alternatively disposed along a second direction, and the first direction is substantially perpendicular to the second direction;
a plurality of light sources, respectively corresponding to the first direction and fixed inside the frame;
an optical film, disposed on the frame and located above the light sources; and
a LCD panel, disposed over the optical film.

30. The LCD apparatus of claim 29, wherein the concave regions are concave surfaces.

31. The LCD apparatus of claim 30, wherein the concave surfaces are arc surfaces.

32. The LCD apparatus of claim 30, wherein each of the light sources is located at a curvature center of one of the concave surfaces.

33. The LCD apparatus of claim 29, further comprising an insulating reflection plate, disposed on the bottom.
